(19) United States
(12) Patent Application Publication
(10) Pub. No.: US 2018/0326817 A1
(43) Pub. Date: Nov. 15, 2018

(54) ELECTRIC HEATER

(71) Applicant: MAHLE International GmbH, Stuffgart (DE)

(72) Inventors: Pascal MISS, Selestat (FR); Gilles MAGNIER, Rougemont-le-Chateau (FR); Eric MARLIER, Kolbsheim (FR)

(73) Assignee: MAHLE International GmbH, Stuttgart (DE)

(21) Appl. No.: 15/978,480

(22) Filed: May 14, 2018

(30) Foreign Application Priority Data
May 12, 2017 (EP) 17170947.0

(51) Int. Cl. B60H 1/22

(52) U.S. Cl. CPC B60H 1/2225; B60H 2001/00128; B60H 1/2218

(57) ABSTRACT

An electric heater in particular for a heating or an air-conditioning system of a motor vehicle, with a heater core having a plurality of electric heating elements having heaters and contact elements to electrically contacting the heaters, said heater core further having a plurality of radiator elements which thermally contact the heating elements, wherein the heater comprises a central portion and two lateral portions, wherein the central portion is arranged between the two lateral portions, wherein the radiator elements are thermally contacting the heater in a central portion and the contact elements are electrically contacting the heater in the lateral portions.

This nonprovisional application claims priority under 35 U.S.C. § 119(a) to European Patent Application No. 17170947.0, which was filed in Europe on May 12, 2018, and which is herein incorporated by reference.

### BACKGROUND OF THE INVENTION

### Field of the Invention

The present invention relates to an electric heater, in particular for a heating or an air-conditioning system of a motor vehicle, especially with an electrical and/or thermal engine, with a heater core comprising a plurality of electric heating elements comprising at least one heater and at least one contact to electrically contact the heater, said heater core further comprising a plurality of radiator elements which are thermally contacting the heater.

### Description of the Background Art

Electric heaters are well known in the art especially for the use as a main heater or an auxiliary heater in a heating or an air-conditioning system of a motor vehicle.

The electric heater is used for example to heat up an air flow generated by a fan of the heating or the air-conditioning system. Such electric heaters often comprise a plurality of electric heating elements which comprise heaters and contact sheets and which are controlled by an electronic controller unit. The electric heating elements are arranged in a heater core together with a plurality of heat dissipating radiator elements which abut against the contact sheets of the electric heating elements or against a tube in which the contact sheets and the heaters are arranged. Since the contact sheets are located between the heaters and the radiator elements they negatively influence the heat flow from the heater to the radiator elements.

The documents EP 2 395 295 A1, EP 2 395 296 A1 and EP 2 397 788 A1 disclose such electric heater with contact sheets contacting the heaters and which are arranged between the heaters and the radiator elements. Therefore the heat flow from the heaters to the radiator elements is reduced. This leads to a reduced heating potential of the ceramic heaters and this leads to the problem that the voltage applied to the ceramic heaters is not the nominal voltage. This leads to problems to control the generated heat of the electric heater.

### SUMMARY OF THE INVENTION

It is therefore an object of the present invention to provide an electric heater which has a better heat performance.

According to an exemplary embodiment of the invention an electric heater is provided, in particular for a heating or an air-conditioning system of a motor vehicle, with a heater core comprising a plurality of electric heating elements comprising at least one heater and at least one contact to electrically contacting the heater, said heater core further comprising a plurality of radiator elements which thermally contact the heating elements, wherein the heater comprises a central portion and two lateral portions, wherein the central portion is arranged between the two lateral portions, wherein the radiator elements are thermally contacting the heater in a central portion and the contact elements are electrically contacting the heater in the lateral portions. This leads to an arrangement in which the thermal contact between the heater and the radiator elements is not negatively influenced by the electrical contact of the heater with the contact elements. Therefore the heat transfer and the electric contact is separated and split to different areas of the heater. According to another aspect the electric heater might be used for other applications too, e.g. for the heating of a coolant of a coolant system, especially to heat a coolant of a high-voltage coolant system.

According to an embodiment of the invention, the heater can have a rectangular cross section with two large side faces and with two short side faces, wherein the central portions are arranged at the middle area of the large side faces and wherein the lateral portions are arranged on the side areas of the large side faces and/or on the short side faces. In particular, the heater is block-shaped with the above mentioned long and short side faces. The two long side faces are arranged oppositely to each other and the two short side faces are arranged oppositely to each other. A short side face is aligned at a right angle with respect to a long side face.

It is of advantage that the lateral portions are arranged only on the short side faces. Therefore the electrical connection of the heater is completely separated from the thermal connection to the radiator elements and transferred to another plane which is located in a right angle to the plane of the thermal connection.

According to an embodiment of the invention, between the heater and the radiator elements, an electrically insulating insulation layer can be arranged. Therefore the heater core is insulated and not on an electrical potential. Therefore the heater core is even usable for high-voltage applications.

According to an embodiment, between the heater and the contact elements on one side and the radiator elements on the other side, an electrically insulating insulation layer can be arranged. Therefore the heater core is more appropriate insulated and usable for high-voltage applications.

Furthermore, it is of advantage, that the heater, the contact elements and the insulation layers are arranged in a tube, wherein the radiator elements are located outside the tube thermally contacting the tube. Therefore the electrical connectable elements are safely located in a tube, which can be closed and sealed such that it is not compromised by dust, dirt or liquids. Furthermore, a tube is more stable against loads from outside the tube.

Furthermore, it is of advantage that the contact elements have metallic elements which elastically contact the heaters. Therefore the contact elements are able to withstand thermal expansion without loosing the electrical contact to the heater.

The contact elements can be glued to the heater with an adhesive agent. This leads to a mechanically very stable connection.

According to an embodiment, the contact elements can include metallic elements which are c-shaped or block-shaped to contact the heater at the lateral portions which are arranged on the side areas of the large side faces and/or on the short side faces. This allows another possibility to electrically connect the heater.

In order to create a safe and stable mechanic and electric connection to the heater, the contact elements can include metallic elements which are overmolded at their back with an electrically insulating plastic material. The overmolded plastic material increases the stability of the electrical contact element.

In an embodiment of the invention it is possible that the electrical contact is mechanically connected to a plastic part and especially arranged in the plastic part.

The insulation layer can be made from a plastic or ceramic material, Kapton, aluminum nitride, or other materials with good dielectric properties and high thermal conductivity. Therefore the layer might be thin and having a good thermal conductivity allowing a good thermal contact between the heater and the radiator element.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a schematic view of an electric heater,

FIG. 2 shows a cross-section of a heating element with radiator elements,

FIG. 3 shows a cross-section of a further embodiment of a heating element with radiator elements,

FIG. 4 shows an arrangement of a heater with contact elements, and

FIG. 5 shows an arrangement of a heater with contact elements.

### DETAILED DESCRIPTION

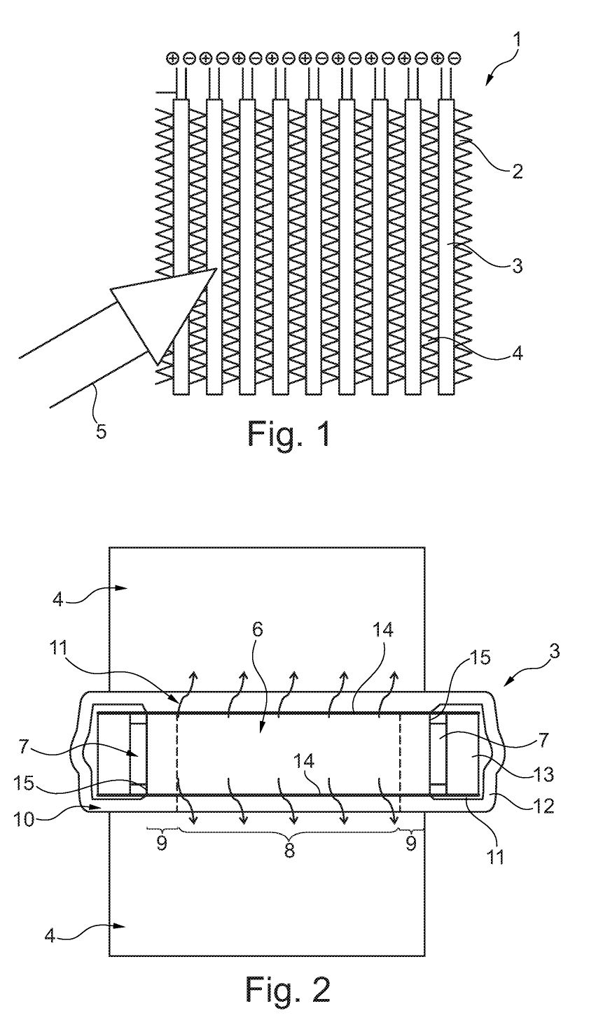

FIG. 1 shows an electric heater 1 with a heater core 2. The electric heater can be an electric heater for a heating or an air-conditioning system of a motor vehicle, for example. The electric heater can be an electric heater for other applications, e.g. for domestic applications.

The heater core 2 comprises a plurality of electric heating elements 3 and a plurality of radiator elements 4. The heating elements 3 are electrically heated due to an electrical current through the heater in the electrical heating element and the radiator elements 4 are transferring the generated heat to an air flow 5 which passes the radiator elements 4. The heater core 2 is made of a sandwich shaped arrangement of heating elements 3 and of radiator elements 4 such that the air flow 5 passing the radiator elements which are located in a space between two heating elements 3 respectively.

FIG. 2 shows a cross-sectional view of a heating element 3 with two radiator elements 4, which are located adjacent to the heating element 3 and on both sides of the heating element 3.

Each heating element 3 comprises at least one or more heaters 6 and at least two contact elements 7 to electrically contacting the heaters 6. The contact elements 7 are electrically connected to a power supply, see e.g. FIG. 1, to allow an electrical current flowing through the heater 6 which generates heat in the heater 6. The power supply to the heater 6 is usually controlled by a control unit, which might be implemented in the electrical heater 1 or which might be located separately from the electrical heater.

The heater 6 can be, for example, resistive heaters 6 or PTC-elements with a positive temperature coefficient of their electrical resistance. A resistive element has usually an increasing resistance with increasing temperature. A PTC-element has an increasing resistance with increasing temperature. A PTC-element is typically a ceramic element.

As can be seen from FIG. 1 said heater core 2 comprises a plurality of radiator elements 4 which are thermally contacting the heating elements 3. Therefore heat can be transferred from the heater 6 to the radiator element 4 and to the air flow through the radiator elements. Instead of air another medium flow is useful too. Therefore the heater core 2 of the electrical heater might be used for liquids or other gases too.

As can be seen in FIG. 2, the heater 6 and the contact elements 7 are located in a tube 10 for securing the heater 6 and the contact elements 7 from outside conditions like dirt, water etc.

As can be seen from FIG. 2 the heater 6 comprises a central portion 8 and two lateral portions 9, wherein the central portion 8 is arranged between the two lateral portions 9. The cross-section of the heater is almost rectangular and the heater is almost block shaped. Therefore the central portion of the heater contacts the tube 10 for allowing a heat transfer to the radiator elements 4. In the area of the central portion 8 the tube has a protruding portion which thermally contacts the heater.

Within the tube 10, there are located insulating layers 11, which are located between the heater 6 and the tube 10 or between the heater 6 and the radiator elements 4. The insulating layer additionally insulates the contact elements 7 electrically against the tube. Between the contact element and a lateral face 12 of the tube 10, there is an additional insulation material 13 as overmold material, which supports the contact element 7. The contact elements 7 are contacting the heater at the lateral portions 9 of the heater 6.

In other words, the radiator elements 4 are contacting the heater 6 in a central portion 8 and the contact elements 7 are contacting the heater 6 in the lateral portions 9. Therefore the thermal contacts and the electrical contacts of the heater are separated from each other.

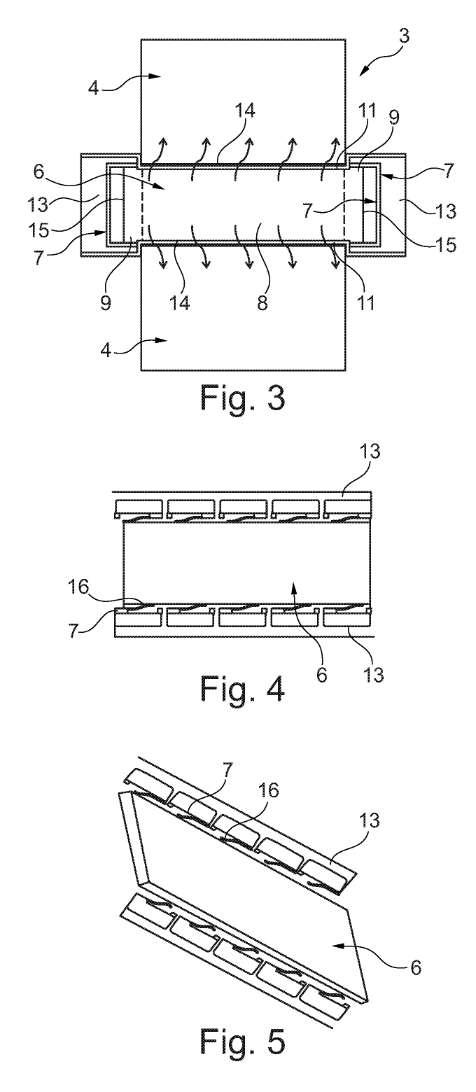

FIG. 3 shows another embodiment of an inventive electrical heater, which shows an arrangement similar to the arrangement of FIG. 2 but without a tube surrounding the heater 6.

Each heating element 3 according to an embodiment comprises at least one or more heaters 6 and at least two contact elements 7 to electrically contacting the heater 6. The contact elements 7 are electrically connected to a power supply, see e.g. FIG. 1, to allow an electrical current flowing through the heater 6 which generates heat in the heater 6. The power supply to the heater 6 is usually controlled by a control unit, which might be implemented in the electrical heater 1 or which might be located separately from the electrical heater.

The heater 6 can be resistive heaters 6 or PTC-elements with a positive temperature coefficient of their electrical resistance. A resistive element has usually an increasing resistance with increasing temperature. A PTC-element has an increasing resistance with increasing temperature. A PTC-element is typically a ceramic element.

As can be seen from FIG. 1 said heater core 2 comprises a plurality of radiator elements 4 which are thermally contacting the heating elements 3. Therefore heat can be transferred from the heater 6 to the radiator element 4 and to the air flow 5 through the radiator elements 4. Instead of air another medium flow can be used. Therefore the heater core 2 of the electrical heater might be used for liquids or other gases.

As can be seen in FIG. 3, the heater 6 and the contact elements 7 are not located in a tube but in general, it might be possible to arrange a tube like tube 10 of FIG. 2 for securing the heater 6 and the contact elements 7 from outside conditions like dirt, water etc. In the shown embodiment the heater 6 is surrounded by the insulation layer 11 and with the contact element 7 with the overmolded back 13. Therefore the heater 6 are protected from dirt, water etc. too.

As can be seen from FIG. 3 the heater 6 comprises a central portion 8 and two lateral portions 9, wherein the central portion 8 is arranged between the two lateral portions 9. The cross-section of the heater 6 is almost rectangular and the heater 6 is almost block shaped. Therefore the central portion 8 of the heater 6 contacts the radiator elements 4 for heat transfer to the radiator elements 4.

On the surface of the heater 6, insulating layers 11 can be arranged between the heater 6 and the radiator elements 4. The insulating layer additionally insulates the contact elements 7 electrically against the tube. The insulation layer 11 is located on the overmolded back 13 of the contact element 7. On the back of the c-shaped contact element 7 is the additional insulation material 13 as overmold material provided, which supports the contact element 7. The contact elements 7 are contacting the heater at the lateral portions 9 of the heater 6.

In other words, the radiator elements 4 are contacting the heater 6 in a central portion 8 and the contact elements 7 are contacting the heater 6 in the lateral portions 9. Therefore the thermal contacts and the electrical contacts of the heater 6 are spatial separated from each other.

As can be seen from FIGS. 2 and 3 the heater 6 has a rectangular cross section with two large side faces 14 and with two short side faces 15, wherein the central portions 8 are arranged at the middle area of the large side faces 14 and wherein the lateral portions 9 are arranged on the side areas of the large side faces 14 and/or on the short side faces 15. Therefore the thermal contact is provided in a more middle area of the heater 6 and the electrical contact is located at the lateral areas of the heater 6.

According to an embodiment the lateral portions 9 are arranged only on the short side faces 15. This allows a clear spatial separation of the thermal contact and the electrical contact.

In order to electrically contact the heater 6, the contact elements 7 are including metallic elements 16 which elastically contact the heater 6. Therefore the contact elements 7 act as springs or are provided with spring elements, as can be seen in FIGS. 4 and 5.

As can be seen in FIG. 2 or 3 the contact elements 7 are including metallic elements 16 which are c-shaped or block-shaped or tongue-shaped to contact the heater 6 at the lateral portions which are arranged on the side areas of the large side faces 14 and/or on the short side faces 15. Between the metallic element 16 and the heater 6 a welding connection or a gluing connection is possible too.

In order to support the contact elements 7, they are provided with an overmolded plastic material on their back. This supports the spring forces acting against the heater.

The insulation layer 11 can be a plastic or ceramic material.

According to an embodiment, the contact elements 7 can be glued to the heater 6.

With regard to the insulation layer 11 the insulation layer can be made from a plastic or ceramic material or another material with high thermal conductivity and good dielectric properties.

In this respect high thermal conductivity means that the thermal conductivity is in a range of 1 W/mK or more up to e.g. 20 W/mK or up to 200 W/mK or more. Having a layer of thickness of larger than 0.5 mm the thermal conductivity is favorable more than 20 W/mK or between 20 W/mK and 200 W/mK or more. Having a layer of thickness of less than 0.5 mm the thermal conductivity is favorable more than 1 W/mK or between 1 W/mK and 20 W/mK or more.

In this respect a material with good dielectric properties means a material having a CTI value (Comparative Tracking Index) of, for example, 600 or more.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. An electric heater for a heating or an air-conditioning system of a motor vehicle, with a heater core comprising:
a plurality of electric heating elements having at least one heater and at least one contact element to electrically contacting the heater; and
a plurality of radiator elements that are thermally contacting the heating elements,
wherein the heater comprises a central portion and two lateral portions,
wherein the central portion is arranged between the two lateral portions,
wherein the radiator elements are thermally contacting the heater in a central portion, and
wherein the contact elements are electrically contacting the heater in lateral portions.

2. The electric heater according to claim 1, wherein the heater has a rectangular cross section with two large side faces and with two short side faces, wherein the central portions are arranged at a middle area of the large side faces, and wherein the lateral portions are arranged on side areas of the large side faces and/or on the short side faces.

3. The electric heater according to claim 2, wherein the lateral portions are arranged only on the short side faces.

4. The electric heater according to claim 1, wherein, between the heater and the radiator elements, an electrically insulating insulation layer is arranged.

5. The electric heater according to claim 1, wherein, between the heater and the contact elements on one side and the radiator elements on the other side, an electrically insulating insulation layer is arranged.

6. The electric heater according to claim 1, wherein the heater, the contact elements, and the insulation layers are arranged in a tube, and wherein the radiator elements are located outside the tube and thermally contact the tube.

7. The electric heater according to claim 1, wherein the contact elements have metallic elements that elastically contact the heater.

8. The electric heater according to claim 1, wherein the contact elements have metallic elements that are c-shaped or block-shaped or tongue-shaped to contact the heater at lateral portions that are arranged on side areas of the large side faces and/or on short side faces.

9. The electric heater according to claim 1, wherein the contact elements have metallic elements that are overmolded with a plastic material or assembled in a plastic part.

10. The electric heater according to claim 1, wherein the contact elements are glued to the heating element.

11. The electric heater according to claim 1, wherein the insulation layer is provided from a plastic or ceramic material or another material with high thermal conductivity and good dielectric properties.
